(19) United States
(12) Patent Application Publication
(10) Pub. No.: US 2006/0079206 A1
(43) Pub. Date: Apr. 13, 2006

(54) Terminal device for preventing resource waste and a control method thereof

(75) Inventor: Jin-Hyung Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/230,495

(22) Filed: Sep. 21, 2005

(30) Foreign Application Priority Data
Sep. 24, 2004 (KR) 2004-77377

(51) Int. Cl. H04M 1/66

(52) U.S. Cl. 455/411

(57) ABSTRACT

A terminal device for preventing the waste of resources is connected to an authentication server and at least one external device through networks, and a method for controlling the same. The terminal device comprises a communication module for requesting authentication in connection with the authentication server and receiving a result of the authentication request, and a control module for converting an operation mode to a communication mode based on the result of the authentication request when the authentication request is approved, the communication module is enabled for communication with the external devices. The operation mode is converted to a power saving mode when the authentication request is not approved.

### CROSS-REFERENCE TO RELATED APPLICATION

This application claims the benefit under 35 U.S.C. §119(a) of Korean Patent Application No. 2004-77377, filed Sep. 24, 2004, in the Korean Intellectual Property Office, the entire disclosure of which is hereby incorporated by reference.

### BACKGROUND OF THE INVENTION

1. Field of the Invention

The present invention relates to a terminal device for preventing the waste of resources and a controlling method thereof. More particularly, the present invention relates to a terminal device for preventing resource waste caused when a compensation operation fails in a wireless network and a controlling method for the same.

2. Description of the Related Art

Networks are connected to a plurality of terminal devices through wired or wireless means. Since the wired network is spatially limited, the wireless network which guarantees mobility has become more prevalent.

In order to construct a wireless network, each terminal device needs to be equipped with a wireless communication module. By selectively setting the operation of the wireless communication module to either an Ad-hoc mode or an infrastructure mode, the wireless network can be configured differently.

The Ad-hoc mode operates in the same way as a peer-to-peer system. The Ad-hoc mode in which the terminal devices are directly connected, comprise only the terminal devices mounting a wireless local area network (LAN), and therefore, the terminal devices are not connected to external networks.

The infrastructure mode is structured in a similar way with a conventional network using a wired LAN. Therefore, the terminal devices can operate with the conventional wired networks through an access point that operates as a wired or wireless connection relay device.

In the wireless network as described above, security is a significant matter because communication data is transmitted in a radio frequency (RF) signal form through the wireless network and therefore is apt to be exposed to unauthorized use.

As a result, the Institute of Electrical and Electronics Engineers (IEEE) 802.11 commission has suggested a wired equivalent privacy (WEP) method as an encoding method and a shared key method as an authentication method.

However, as security defects of the above methods had been found, IEEE 802.11i was introduced through WiFi Protected Access (WPA).

According to the IEEE 802.11i, the encoding methods such as Advanced Encryption Standard (AES), Temporal Key Integrity Protocol (TKIP) and a Pre-shared key, and authentication methods such as Extensible Authentication Protocol-Transport Layer Security (EAP-TLS), Extensible Authentication Protocol-Turnneled Transport Layer Security (EAP-TTLS) and Protected Extensible Authentication Protocol (PEAP), which are authenticated by Remote Authentication Dial-In User Service (RADIUS) are added, thereby improving the level of security as compared to the WPA.

In the conventional wireless communication system as the above, when the securing operations like the authentication and the encoding fail, the system repeatedly tries the securing operations or just stands by in a general mode. Therefore, electricity and wireless bandwidth resources are wasted.

### SUMMARY OF THE INVENTION

An aspect of the present invention is to solve at least the above problems and/or disadvantages and to provide at least the advantages described below. Accordingly, an aspect of the present invention is to provide a terminal device capable of preventing the waste of resources, such as electricity and bandwidth, by converting to an operation mode for minimizing resource consumption of the terminal device and communication module when securing operations such as authentication and encoding fail, and a method for controlling the same.

In order to achieve the above-described aspects of the present invention, there is provided a terminal device for preventing the waste of resources, which is connected to an authentication server and at least one external device through networks, the terminal device comprises a communication module for requesting the authentication in connection with the authentication server and receiving a result of the authentication request; and a control module, according to the result of the authentication request, for converting an operation mode to a communication mode when the authentication is approved, thereby enabling communication of the external devices by the communication module, and converting the operation mode to a power saving mode when the authentication is not approved.

The external devices are authenticated by the authentication server. The control module converts the operation mode to the power saving mode and stops the operation of the communication module. For transmission of data to the external devices, the communication module encodes the data.

The control module determines whether the data is successfully encoded by the communication module to enable communication of the external devices by the communication module when the encoding succeeds, and converts the operation mode when the encoding fails.

The terminal device may be a computer, and the external devices may comprise an image forming apparatus.

Another aspect of the present invention is to provide a method for controlling a terminal device for preventing the waste of resources comprising the steps of connecting to the authentication server and requesting authentication; receiving a result of the authentication request; and according to the result of the authentication request, converting an operation mode to a communication mode to enable communication with the external devices when the authentication is approved, and converting the operation mode to a power saving mode when the authentication is not approved.

The method may further comprise the step of encoding data to be transmitted to the external devices when the authentication is approved by the authentication server.

The method may further comprise the step of determining whether the data is successfully encoded to communicate with the external devices when the encoding succeeds, and converting the operation mode to a power saving mode when the encoding fails.

### BRIEF DESCRIPTION OF THE DRAWINGS

The above aspect and other features of the present invention will become more apparent by describing in detail exemplary embodiments thereof with reference to the attached drawing figures, wherein;

FIG. 1 is a diagram showing a network system according to an embodiment of the present invention;

FIG. 2 is a block diagram illustrating a terminal device for preventing the waste of resources according to an embodiment of the present invention; and

FIG. 3 is a flowchart of a method for controlling a terminal device which prevents the waste of resources according to an embodiment of the present invention.

Throughout the drawings, it should be understood that like refer to like features, structures and elements.

### DETAILED DESCRIPTION OF THE EXEMPLARY EMBODIMENT

Hereinafter, an embodiment of the present invention will be described in detail with reference to the accompanying drawing figures.

The matters defined in the description such as a detailed construction and elements are provided to assist in a comprehensive understanding of the invention. Descriptions of well-known functions or constructions are omitted for the sake of clarity and conciseness.

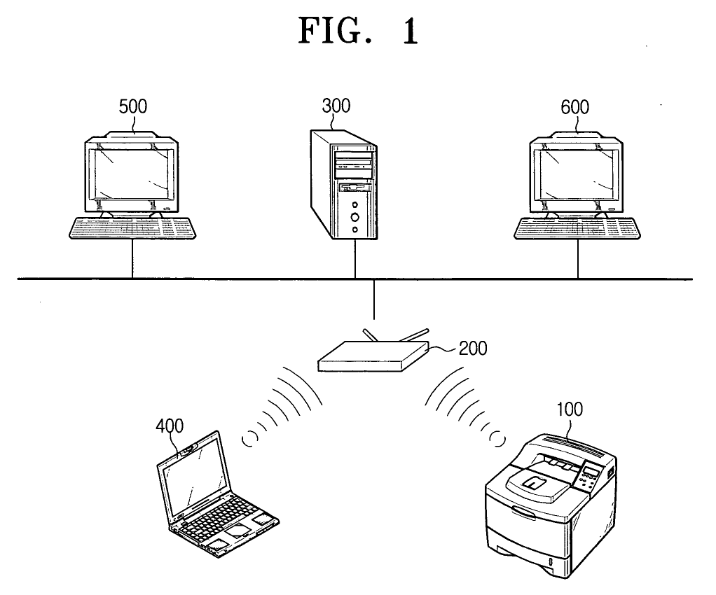

FIG. 1 is a diagram illustrating a network system according to an embodiment of the present invention. In the network system according to an embodiment of the present invention, a plurality of terminal devices are connected to an authentication server 300 through different types of networks, and the plurality of terminal devices authenticated by the authentication server 300 communicate with one another.

The network system according to an embodiment of the present invention comprises a printer server 100, an access point 200, the authentication server 300, a first computer 400, a second computer 500 and a third computer 600.

Operation modes of the printer server 100 and the first to the third computers 400 through 600, respectively, preferably include a general standby mode for awaiting data reception and transmission, a power saving mode in which minimal power is consumed and a communication mode in which communication with other devices is available.

The printer server 100 is connected through networks with the authentication server 300 and the first to third computers 400 through 600, respectively. The printer server 100 requests authentication by transmitting an authentication key to the authentication server 300 to use the networks. When the authentication request is approved, the printer server 100 transceives data with the first to the third computers 400 through 600, respectively.

The access point 200 used in constructing a wireless LAN, relays data transmissions between printer server 100 and the first to the third computers 400 through 600, respectively.

The authentication server 300 receives the authentication key, for example, a user identification (ID) and a password, from the printer server 100 or the first to the third computers 400 through 600, respectively and authenticates the use of the networks by the respective device.

Here, the authentication server 300 may include a database for storing particular authentication keys respectively allocated to the first to the third computers 400 through 600, respectively in order to approve or reject the authentication according to the authentication request of the printer server 100 or the first to the third computers 400 through 600, respectively. The authentication server 300 usually employs the RADIUS server.

The first computer 400 is connected to the authentication server 300, the printer server 100 and the second 500 and the third 600 computers through the networks. The first computer 400 requests the authentication of the authentication server 300 and transceives data with the printer server 100, the second 500 and the third 600 computers.

The second computer 500 is connected to the authentication server 300, the printer server 100 and the first and the third computers 400 and 600 through the networks. The second computer 500 requests authentication of the authentication server 300 and transceives data with the printer server 100 and the first 400 and third 600 computers.

The third computer 600 is connected to the authentication server 300, the printer server 100 and the first and the second computers 400 and 500 through the networks. The third computer 600 also requests authentication of the authentication server 300 and transceives data with the printer server 100 and the first and the second computers 400 and 500.

Although the present embodiment applies the terminal device as the printer device 100 and external devices as the first to third computers 400 through 600, respectively, this is only an example in terms of the printer server 100. In other words, if the first computer 400 is the terminal device, the printer server 100, the second computer 500 and the third computer 600 serve as the external devices.

Also, according to an embodiment of the present invention, when turned on and booted, the printer server 100 and the first to third computers 400 through 600, respectively can be connected to the authentication server 300 to request the authentication and can periodically request the authentication while the power is on.

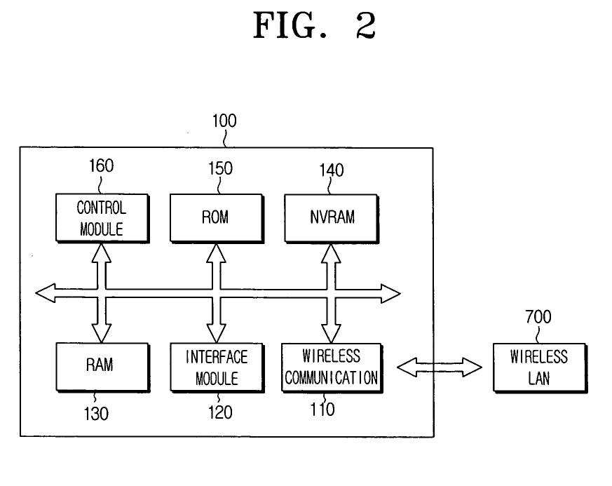

FIG. 2 is a block diagram illustrating a terminal device for preventing the waste of resources according to an embodiment of the present invention.

The terminal device according to an embodiment of the present invention, that is, the printer server 100 comprises a wireless communication module 110, an interface module 120, a random access memory (RAM) 130, a nonvolatile random access memory (NVRAM) 140, a read-only memory (ROM) and a control module 160.

The wireless communication module 110 connects with the authentication server 300 by connection with a wireless local area network (LAN) 700, and transmits the user's ID and the password to the authentication server 300 for approval of the authentication request by the authentication server 300. Then, the wireless communication module 110 receives the result of the authentication request transmitted from the authentication server 300.

The wireless communication module 110 receives the result of the authentication request from the authentication server 300 and, if the control module 160 determines that the authentication request is approved, encodes the data for transmission to any one of the first to third computers 400 through 600, respectively.

A data packet is encoded by a certain encoding algorithm using a key value input by the user or a key value allocated by the authentication server 300. Therefore, if the key value or the encoding method is wrongly set, the data is abnormally encoded, and accordingly, communication cannot be made.

The interface module 120 offers an interface between the terminal device and peripheral devices, thereby enabling communication with the printer server 100 and one of the first to third computers 400 through 600, respectively.

The RAM 130 is a volatile memory for temporarily storing data generated while the control module 160 is performing programs. More specifically, the RAM 130 is a memory which maintains an operation system, an application program and currently-used data in order for prompt access of a processor.

The NVRAM 140 is a RAM capable of preserving the stored data although the external power of the printer server 100 is turned off or lost. Generally, the NVRAM 140 may offer a static RAM (SRAM) including a backup battery or may store to an electrically erasable and programmable ROM (EEPROM) and restores the data.

The ROM 150 is a non-volatile memory for storing a variety of control programs for fulfilling functions of the printer server 100. For example, the ROM 150 may store thereto a program for booting and resetting the printer server 100, the authentication key and the encoding algorithm.

The control module 160 determines whether the authentication request received by the wireless communication module 110 is approved. When the authentication request is approved by the authentication server 300, the control module 160 converts the operation mode to the communication mode to enable the communication by the communication module 110 among the first to third computers 400 through 600, respectively.

If the authentication request is not approved by the authentication server 300, the control module 160 converts the operation mode of the printer server 100 to the power saving mode to reduce consumption of the power and stops the operation of the wireless communication module 110 to prevent the waste of wireless resources, such as bandwidth.

When the authentication request is approved by the authentication server 300, and therefore, communication among the printer server 100 and the first to third computers 400 through 600, respectively become available, the control module 160 controls the communication module 110 to encode the data for transmission.

The control module 160 determines whether the data encoding is properly performed by the communication module 110. When the data encoding is successfully performed, the control module 160 controls the communication module 100 to communicate with the first to third computers 400 through 600, respectively. When the data encoding fails, the control module 160 converts the operation mode of the printer server 100 to the power saving mode. Successful encoding is achieved when the communication error rate is below a selected threshold, thereby enabling communication between external devices and the communication module 100.

The above construction is also applied in the same way when the terminal device is the printer server 100 or one of the first to third computers 400 through 600, respectively. Also, other construction can be added according to the functions of each terminal device. For example, the printer server 100 may further comprise a print engine to perform printing operations.

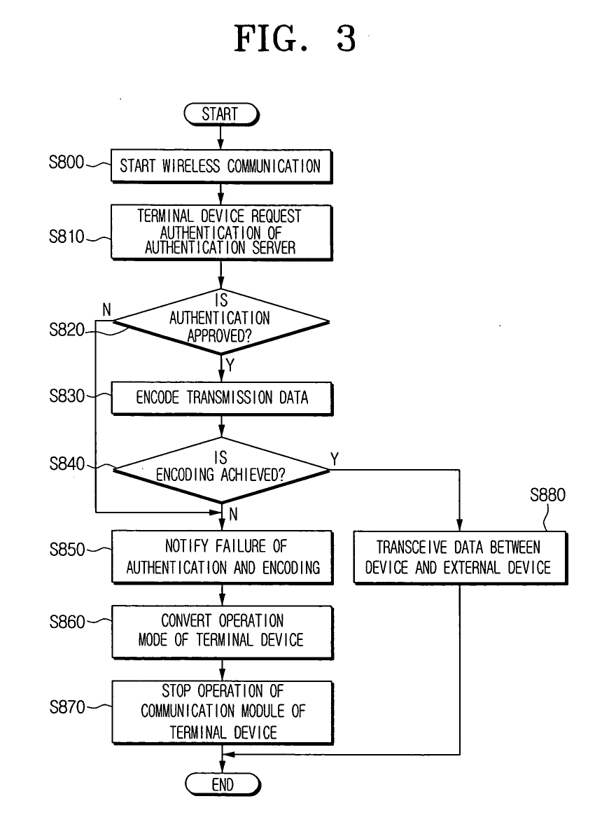

FIG. 3 is a flowchart of a method for controlling the terminal device for preventing the waste of resources, according to an embodiment of the present invention.

Hereinbelow, the method for controlling resources of the terminal device will be described with reference to FIGS. 1 through 3 according to an embodiment of the present invention. In this embodiment, the printer server 100 intends to transmit data to the first computer 400. Although, data could also be transmitted to either computer 500 or 600 or both.

The printer server 100 and the first to third computers 400 through 600, respectively connects with the wireless network through the respective wireless communication modules 110 (S800). The printer server 100 and the first to third computers 400 through 600, respectively transmit the authentication key to the authentication server 300 through the wireless communication modules 110 to request the authentication (S810).

The authentication server 300 compares the authentication keys transmitted from the printer server 100 and the first to third computers 400 through 600, respectively and the respective authentication keys, which are pre-stored, and approves the authentication request only when the compared authentication keys correspond to each other. Then, the authentication server 300 transmits the result of the authentication request to the printer server 100 and the first to third computers 400 through 600, respectively (S820).

When the authentication is approved in step S820, the printer server 100 encodes the data to be transmitted to the first computer 400 (S830). If the authentication is not approved in step S820, the authentication server 300 notifies the printer server 100 of the failure of authentication request (S850).

When the encoding of the data for transmission from the printer server 100 to the first computer 400 is successfully performed (S840), communication between the printer server 100 and the first computer 400 is enabled. Therefore, the printer server 100 transmits the encoded data and the first computer 400 receives and decodes the encoded data (S880).

When it is determined that the encoding of the data is not performed in step S840, the printer server 100 notifies the printer server 100 of the failure of the authentication (S850), and the control module 160 of the printer server 100 converts the operation mode to the power saving mode (S860).

Additionally, the control module 160 controls the wireless communication module 110 to stop its operation, thereby preventing the waste of the wireless resources (S870).

As can be appreciated from the description of the terminal device for preventing the waste of resources and the method therefore according to the embodiments of the present invention, when the security operations such as the authentication and the encoding fail, the operation mode of the terminal device is converted to the power saving mode. Accordingly, power consumption can be minimized.

Furthermore, when the security operations fail, the operations of the wireless communication module are suspended, thereby preventing the waste of the wireless resources without affecting the wireless communication among the other terminal devices.

While the invention has been shown and described with reference to certain embodiments thereof, it will be understood by those skilled in the art that various changes in form and details may be made therein without departing from the spirit and scope of the invention as defined by the appended claims.

What is claimed is:

1. A terminal device connected to an authentication server and at least one external device through networks for preventing waste of resources, the terminal device comprising:
a communication module for requesting authentication in connection with the authentication server and receiving a result of the authentication request; and
a control module, according to the result of the authentication request, for converting an operation mode to a communication mode when the authentication request is approved, thereby enabling communication with the external devices by the communication module, and converting the operation mode to a power saving mode when the authentication request is not approved.

2. The terminal device of claim 1, wherein the external devices are authenticated by the authentication server.

3. The terminal device of claim 1, wherein the control module converts the operation mode to the power saving mode and stops the operation of the communication module.

4. The terminal device of claim 3, wherein the operations of the communication module are stopped when an authentication request is not approved.

5. The terminal device of claim 1, wherein, for transmission of data to the external devices, the communication module encodes the data.

6. The terminal device of claim 5, wherein the control module determines whether the data is properly encoded by the communication module to enable communication of the external devices by the communication module when the encoding succeeds, and converts the operation mode when the encoding fails.

7. The terminal device of claim 1, wherein the terminal device is a computer.

8. The terminal device of claim 1, wherein the external devices comprise an image forming apparatus.

9. A method for controlling a terminal device connected to an authentication server and at least one external device through networks for preventing waste of resources, the method comprising the steps of:
connecting to the authentication server and requesting authentication;
receiving a result of the authentication request; and
based on the result of the authentication request, converting an operation mode to a communication mode to enable communication with the external devices when the authentication request is approved, and converting the operation mode to a power saving mode when the authentication request is not approved.

10. The method of claim 9, wherein the external devices are authenticated by the authentication server.

11. The method of claim 9, further comprising the step of encoding data to be transmitted to the external devices when the authentication request is approved by the authentication server.

12. The method of claim 11, further comprising the step of determining whether the data is properly encoded to communicate with the external devices when the encoding succeeds, and converting the operation mode when the encoding fails.

13. The method of claim 9, wherein the step of converting the operation mode to the power saving mode further comprises the step of stopping communications with the external devices.

14. The method of claim 13, wherein the step of stopping communications with the external devices is based on an authentication request not being approved.

15. The method of claim 9 further comprises the steps of:
encoding data to be transmitted to an external device; and
transmitting the encoded data to the external devices.
